(19) United States
(12) Patent Application Publication
(10) Pub. No.: US 2006/0204619 A1
(43) Pub. Date: Sep. 14, 2006

(54) Food preparation

(76) Inventors: Sonia Bocchi, Sorbolo (Parma) (IT); Barbara Cavalieri, Basilicanova (Parma) (IT); Andrea Fanzaghi, Salsomaggiore Terme (Parma) (IT); Franco Dameno, Piacenza (IT)

Correspondence Address: MCDERMOTT WILL & EMERY LLP, 600 13TH STREET, N.W., WASHINGTON, DC, 20005-3096, US

(21) Appl. No.: 11/361,043

(22) Filed: Feb. 24, 2006

(30) Foreign Application Priority Data
Feb. 25, 2005 (EP) 05425104.6

(51) Int. Cl. A21D 13/00

(52) U.S. Cl. 426/94

(57) ABSTRACT

Food preparation comprising a tomato sauce base and a plurality of rissoles containing at least one foodstuff chosen among fish, vegetables and legumes in an amount of at least 20% by weight of the total weight of said rissoles and optionally white meats, in particular chicken and/or turkey.

### FIELD OF APPLICATION

In its more general aspect the present invention refers to the food industry sector.

In particular, the present invention refers to a new type of condiment for pasta, rice and the like, particularly suitable to meet children's preferences and having a particularly balanced dietetic-nutritional profile.

### STATE OF THE ART

It is common knowledge that a diet which is both balanced and adequate to keep the body in good health and shape must be very varied, low in fats and, on the other hand, rich in fruits and vegetables.

It is also widely known that in a healthy and balanced diet protein intake should be varied, that is, given by both animal proteins, such as red and white meats and fish, and plant proteins, such as those found in legumes (also important for their fiber content).

However, it is just as widely known that children usually have a strong dislike for fish, vegetables and legumes, especially if such foods are served in a way that does not encourage consumption (for example, fish that has not been de-boned, vegetables in rather large chunks, whole legumes, etc.).

As a consequence, children's diets tend to be quite low in those very foods which we are currently being advised to consume.

The problem which the Applicant has dealt with is that of providing a food preparation which on the one hand contains the healthy foods mentioned above (white meats, fish, vegetables and/or legumes) and on the other hand exhibits textural and organoleptic properties such that they appeal also to those who usually have a dislike for most of such foods, such as children.

### SUMMARY OF THE INVENTION

Such a problem has been solved, according to the invention, by a food preparation comprising a tomato sauce base and a plurality of rissoles containing at least one foodstuff chosen among fish, vegetables and legumes in an amount of at least 20% by weight of the total weight of said rissoles and optionally white meats such as chicken and turkey.

The aforementioned rissoles generally constitute 25-50% by weight of the total weight of the preparation and preferably contain 25-45% by weight of one or more foodstuffs chosen among fish, vegetables and legumes.

Typically, they also include at least one protein binder, usually consisting of whole eggs but also egg white, soy proteins or mixtures of such binders.

Preferably, to achieve an effective flavor adjustment, the rissoles also contain cheese, in particular hard cheese, for example grated Parmigiano Reggiano or Grana Padano and/or ricotta cheese.

The texture of the rissoles may be modified by the optional addition of cereal grain flours, bread-crumbs, starches, potatoes, cream, etc.

The typical weight of each rissole is around 3-5 g.

The tomato sauce base includes tomato pulp, finely chopped vegetables (e.g. onion, carrot, celery, pumpkin), olive oil, salt and sugar.

The food preparation according to the invention is typically used as a condiment for pasta, rice and the like, thus producing a nutritionally balanced dish in terms of carbohydrate, protein and fat content.

The rissoles and the tomato sauce base are prepared separately and then mixed in the appropriate proportions at the time of filling of the preparation in small jars or other suitable containers.

The rissoles are prepared by extrusion of a pasty mixture containing the above mentioned ingredients, cutting of the extruded mixture rope in 3.5-4.5 g portions, steam pasteurization of such portions, which constitute the rissoles to be added to the tomato sauce base.

The sauce base is prepared using conventional techniques, particular care being given to the chopping of the vegetables contained therein, so as to avert the occurrence of chunks large enough to be perceived by children's sensitive palates.

A set number of pasteurized rissoles are then dispensed inside small jars and the jar is then filled under vacuum with the tomato sauce base.

The filled jars are then hermetically sealed and sterilized by autoclaving.

### DETAILED DESCRIPTION

The present invention will be further described with reference to some examples given for illustrative but not limiting purposes.

### EXAMPLE 1

Fish rissoles

| | |
|---|---|
| Grana Padano | 40 |
| Trout | 23.5 |
| Perch | 18 |
| Bread-crumbs | 8 |
| Potatoes | 5 |
| Eggs | 2 |
| Salt | 1.5 |
| Dietary fiber | 1 |
| Flour | 1 |

The values shown above are expressed in percentage weight of the total weight of the composition.

The trout and the perch are minced to a puree in an industrial-type mincer, and are mixed with the previously grated Grana Padano, the bread-crumbs, potatoes, eggs, salt, dietary fiber and the flour in a mixer.

Once a homogeneous pasty mixture is obtained, it is fed under vacuum to an extruder. A strand of the mixture comes out of the extruder die and is cut by means of cutting procedures into portions uniform in size and so as to weigh around 4 g each.

Such portions, which constitute the rissoles according to the invention, are placed onto a conveyor belt and sent to a steam pasteurization apparatus. Following a steam treatment at 90°-95° C. for around 3-5 minutes, 16 pasteurized rissoles are dispensed into 200 ml glass jars. The jars are then filled with the tomato sauce base as hereunder reported.

Tomato sauce base

| | |
|---|---|
| Tomato pulp | 51 |
| Carrots | 20 |
| Onions | 9 |
| Tomato concentrate | 6.5 |
| Olive oil | 6 |
| Celery | 4.5 |
| Salt | 1.5 |
| Sugar | 1.5 |

In this case also, the values shown above are expressed in percentage weight of the total weight of the tomato sauce.

A tomato sauce was prepared with the ingredients reported above, using the conventional procedures known in the field.

Finally, the sauce was dispensed in the jars already containing the rissoles, in such an amount so as to fill each jar.

Finally, the filled jars were hermetically sealed and sterilized by autoclaving at 121° C. for 9-10 minutes.

Legume and turkey meat based rissoles

| | |
|---|---|
| Grana Padano | 25 |
| Turkey | 14 |
| Chick peas | 13 |
| Cannellini beans | 13 |
| Borlotti beans | 13 |
| Carrots | 8 |
| Water | 5 |
| Potatoes | 2 |
| Eggs | 2 |
| Bread-crumbs | 2 |
| Flour | 1 |
| Dietary fiber | 1 |
| Salt | 1 |

The values shown above are expressed in percentage weight of the total weight of the composition.

The chick peas, and the beans, pre-cooked and re-hydrated with water, were reduced to a puree to which the finely minced turkey meat, the previously grated Grana Padano, the eggs, bread-crumbs, flour, celery, potatoes and (finely chopped) carrots, salt, flour and the dietary fiber were added, in a mixer.

Then, the rissoles, 4 g in weight each, were prepared as described in example 1 and were steam pasteurized according to the procedures set out in example 1 and then dispensed into 200 ml glass jars, 16 in each jar.

Finally, the jars were filled with the tomato sauce base described in example 1 (to which other types of vegetables may be added, for example pumpkin), hermetically sealed and sterilized by autoclaving at 121° C. for 9-10 minutes.

Vegetable and chicken meat rissoles

| | |
|---|---|
| Chicken | 30 |
| Grana Padano | 20 |
| Bread-crumbs | 13 |
| Carrots | 8 |
| Pumpkin | 7 |
| Zucchini | 6 |
| Spinach | 6 |
| Celery | 3 |
| Cream | 3 |
| Eggs | 1 |
| Dietary fibre | 1 |
| Salt | 1 |
| Flour | 1 |

The values shown above are expressed as percentage weight of the total weight of the composition.

The vegetables listed above were reduced to a puree to which the previously minced chicken meat, the previously grated Parmigiano Reggiano, the eggs, bread-crumbs, cream, flour and the dietary fiber and the salt were added, in a mixer.

Then, the rissoles, 4 g in weight each, were prepared as described in example 1 and were steam pasteurized according to the procedures set out in example 1 and deposited in 200 ml glass jars, 16 in each jar.

Finally, the jars were filled with the tomato sauce base described in example 1 (to which ricotta cheese may be added), hermetically sealed and sterilized by autoclaving at 121° C. for 9-10 minutes.

The food preparations obtained according to the three examples described above were used for flavor evaluation tests addressing 8 to 12-year-old children. They were made to taste pasta dishes prepared with the preparations of the three examples, using a pasta to preparation ratio of 1:1. The dishes very much appealed to the children.

1. Food preparation comprising a tomato sauce base and a plurality of rissoles containing at least one foodstuff chosen among fish, vegetables and legumes in an amount of at least 20% by weight of the total weight of said rissoles.

2. Food preparation according to claim 1, wherein said rissoles further include white meats, in particular chicken and/or turkey.

3. Food preparation according to claim 1, wherein said rissoles constitute 25-50% by weight of the total weight of the preparation.

4. Food preparation according to claim 1, wherein said rissoles contain 25-45% by weight of said at least one foodstuff.

5. Food preparation according to claim 1, further containing at least one protein binder.

6. Food preparation according to claim 3, further containing at least one protein binder.

7. Food preparation according to claim 5, wherein said protein binder consists of whole eggs, egg white, soy proteins and mixtures thereof.

8. Food preparation according to claim 6, wherein said protein binder consists of whole eggs, egg white, soy proteins and mixtures thereof.

9. Food preparation according to claim 1, further containing cheese.

10. Food preparation according to claim 9, wherein said cheese is a grated hard cheese or ricotta cheese.

11. Food preparation according to claim 1, further containing at least one thickener, chosen among cereal grain flours, bread-crumbs, starches and dietary fibers.

12. Food preparation according to claim 3, further containing at least one thickener, chosen among cereal grain flours, bread-crumbs, starches and dietary fibers.

13. Food preparation according to claim 8, further containing at least one thickener, chosen among cereal grain flours, bread-crumbs, starches and dietary fibers.
